(19) United States
(12) Patent Application Publication
(10) Pub. No.: US 2009/0260085 A1
(43) Pub. Date: Oct. 15, 2009

(54) APPARATUS, SYSTEM AND METHOD FOR BLOCKING MALICIOUS CODE

(76) Inventors: Min Sik KIM, Daejeon (KR); Jong Moon LEE, Daejeon (KR); Hyun Dong PARK, Daejeon (KR); Soon Jwa HONG, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/208,708

(22) Filed: Sep. 11, 2008

(30) Foreign Application Priority Data
Apr. 15, 2008 (KR) 10-2008-0034466

(51) Int. Cl. G06F 21/00

(52) U.S. Cl. 726/24

(57) ABSTRACT

Provided are an apparatus, system and method for blocking malicious code. The apparatus includes a first malicious code detector for determining whether or not a received e-mail includes malicious code, on the basis of previously stored malicious code patterns, a second malicious code detector for performing second malicious code detection on a received e-mail determined by the first malicious code detector not to include malicious code, a pattern extractor for extracting a new malicious code pattern from malicious code detected by the second malicious code detector, and a transceiver for transferring the extracted new malicious code pattern to a pattern providing server. According to the apparatus, system and method, when one terminal detects a new malicious code pattern, a pattern providing server rapidly provides the new malicious code pattern to other terminals, and thus it is possible to rapidly and flexibly cope with the spread of malicious codes having new patterns

### CROSS-REFERENCE TO RELATED APPLICATION

This application claims priority to and the benefit of Korean Patent Application No. 2008-34466, filed Apr. 15, 2008, the disclosure of which is incorporated herein by reference in its entirety.

### BACKGROUND

1. Field of the Invention

The present invention relates to an apparatus, system and method for blocking malicious code, and more particularly, to a malicious code blocking apparatus, system and method that efficiently cope with a rapidly spreading malicious code having a new pattern.

2. Discussion of Related Art

With the rapid development and spread of the Internet, the number of e-mail service users has been rapidly increasing and damage caused by malicious codes spread via spam mail is also on the rise.

To prevent the spread of malicious codes, most organizations use solutions for blocking malicious codes. However, most such solutions detect malicious codes on the basis of patterns provided by a network equipment vendor company, and thus their performance is limited. Malicious code patterns provided by vendor companies are extracted from limited network traffic, and the patterns cannot reflect various traffic environments of an actual network. In addition, the one-way pattern providing method used by vendor companies cannot efficiently cope with emergencies. When a terminal operating in one network is infected with malicious code, the malicious code may be rapidly spread by communication between internal terminals. Here, malicious code blocking solutions having poor emergency management capability cannot effectively cope with the spread of new malicious codes such as zero-day attacks.

### SUMMARY OF THE INVENTION

The present invention is directed to providing a malicious code blocking apparatus, system and method capable of effectively blocking malicious codes transferred from terminals in a network, even if malicious code having a new pattern is rapidly spread via e-mail, etc.

One aspect of the present invention provides an apparatus for blocking malicious code, comprising: a first malicious code detector for determining whether or not a received e-mail includes malicious code, on the basis of previously stored malicious code patterns; a second malicious code detector for performing second malicious code detection on a received e-mail determined by the first malicious code detector not to include malicious code; a pattern extractor for extracting a new malicious code pattern from malicious code detected by the second malicious code detector; and a transceiver for transferring the extracted new malicious code pattern to a pattern providing server.

Another aspect of the present invention provides a system for blocking malicious code, comprising: a plurality of malicious code blocking agents for detecting and blocking malicious code on the basis of stored malicious code patterns, detecting malicious code having a new malicious code pattern that differs from the stored malicious code patterns, and extracting the new malicious code pattern from the detected malicious code; and a pattern providing server for providing the new malicious code pattern received from one of the malicious code blocking agents to the other malicious code blocking agents in a network.

Yet another aspect of the present invention provides a method of blocking malicious code, comprising: performing, at a malicious code blocking agent, first malicious code detection for detecting malicious code in a received e-mail on the basis of stored malicious code patterns; when no malicious code is detected through the first malicious code detection, performing, at the malicious code blocking agent, second malicious code detection using a virtual machine; extracting, at the malicious code blocking agent, a new malicious code pattern from malicious code detected through the second malicious code detection; and transferring, at the malicious code blocking agent, the extracted new malicious code pattern to a pattern providing server.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram illustrating operation of a system for blocking malicious code according to an exemplary embodiment of the present invention;

FIG. 2 is a block diagram of a system for blocking malicious code according to an exemplary embodiment of the present invention; and

FIG. 3 is a flowchart showing a method of blocking malicious code according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention. Throughout the drawings and the following descriptions of exemplary embodiments, like numerals denote like elements. In the drawings, the sizes and thicknesses of layers and regions may be exaggerated for clarity.

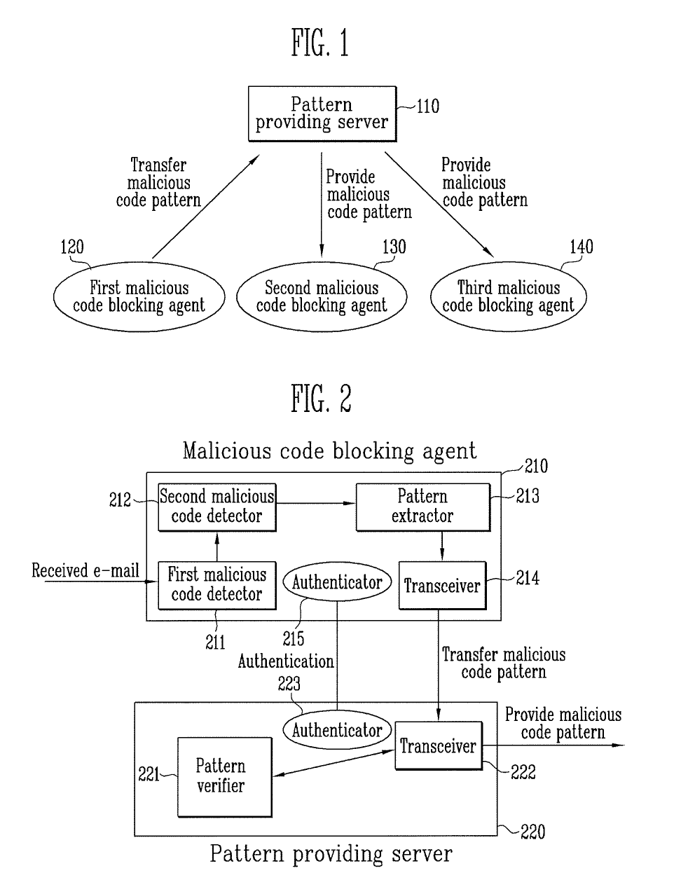

FIG. 1 is a block diagram illustrating operation of a system for blocking malicious code according to an exemplary embodiment of the present invention.

Referring to FIG. 1, the system for blocking malicious code according to an exemplary embodiment of the present invention comprises a pattern providing server 110 and malicious code blocking agents 120, 130 and 140 respectively installed in terminals in a network.

The pattern providing server 100 functions to provide a new malicious code pattern extracted by the malicious code blocking agent 120 to the other malicious code blocking agents 130 and 140. The pattern providing server 110 may perform pattern verification on the new malicious code pattern received from the malicious code blocking agent 120 using a virtual machine, etc.

The malicious code blocking agents 120, 130 and 140 are installed in network components, such as a mail server and Personal Computers (PCs), and detect and block malicious codes on the basis of stored malicious code patterns. In addition, when malicious code having a new pattern that is not stored is detected, the malicious code blocking agents 120, 130 and 140 extract and transfer the pattern of the malicious code to the pattern providing server 110. The malicious code blocking agents 120, 130 and 140 store the new malicious code pattern provided by the pattern providing server 10 and afterwards use it to detect malicious codes.

For example, when the first malicious code blocking agent 120 detects malicious code having a new pattern, it extracts and transfers the new malicious code pattern to the pattern providing server 110. The pattern providing server 110 provides the received new malicious code pattern to the second and third malicious code blocking agents 130 and 140, and the second and third malicious code blocking agents 130 and 140 detect and block malicious codes using the received new malicious code pattern. In this way, it is possible to effectively cope with the spread of malicious codes having new patterns.

FIG. 2 is a block diagram of a system for blocking malicious code according to an exemplary embodiment of the present invention.

Referring to FIG. 2, the system for blocking malicious code according to an exemplary embodiment of the present invention includes a malicious code blocking agent 210 and a pattern providing server 220.

The malicious code blocking agent 210 includes a first malicious code detector 211, a second malicious code detector 212, a pattern extractor 213 and a transceiver 214. The first malicious code detector 211 performs first malicious code detection for determining whether or not an e-mail received by a component in which the malicious code blocking agent 210 is installed includes malicious code, on the basis of stored malicious code patterns.

The second malicious code detector 212 performs second malicious code detection on an e-mail determined by the first malicious code detector 211 not to include malicious code, using a method other than pattern-based malicious code detection. The second malicious code detector 212 may perform the second malicious code detection using a virtual machine.

Here, the virtual machine is a virtual system of an operating system separately managed by a virtual platform within the system, and is mainly used for simulations, etc. The second malicious code detector 212 executes a code suspected to be malicious in a region that does not directly affect the system using such a virtual machine, and thus can safely detect various malicious operations, such as file infection or deletion, connection to an Internet Relay Chat (IRC) server, transfer of e-mail and opening of a listening port. However, malicious code detection using a virtual machine requires considerably more resources and time than pattern-based malicious code detection. Therefore, to detect malicious codes having new patterns, the system for blocking malicious code according to an exemplary embodiment of the present invention performs the second detection on only malicious codes not detected by pattern-based malicious code detection. The first and second malicious code detectors 211 and 212 may block malicious codes by deleting or returning an e-mail determined to include malicious code, or by using some other methods.

The pattern extractor 213 extracts the pattern of malicious code detected by the second malicious code detector 212. The transceiver 214 transfers the new malicious code pattern extracted by the pattern extractor 213 to the pattern providing server 220, and receives a malicious code pattern provided by the pattern providing server 220. The transceiver 214 also may directly transfer the new malicious code pattern to another malicious code blocking agent.

When the transceiver 214 receives a new malicious code pattern, the first malicious code detector 211 stores the received malicious code pattern and may use it to detect malicious codes afterwards.

The pattern providing server 220 includes a pattern verifier 221 and a transceiver 222. The pattern verifier 221 verifies a new malicious code pattern received through the transceiver 222 using a virtual machine, etc. When the verification of the new malicious code pattern is completed, the transceiver 222 transfers the new malicious code pattern to respective malicious code blocking agents. To ensure the reliability of pattern exchange, the malicious code blocking agent 210 and the pattern providing server 220 may include authenticators 215 and 223 for performing an authentication process of verifying each other using an authentication key, etc., before exchanging the new malicious code pattern.

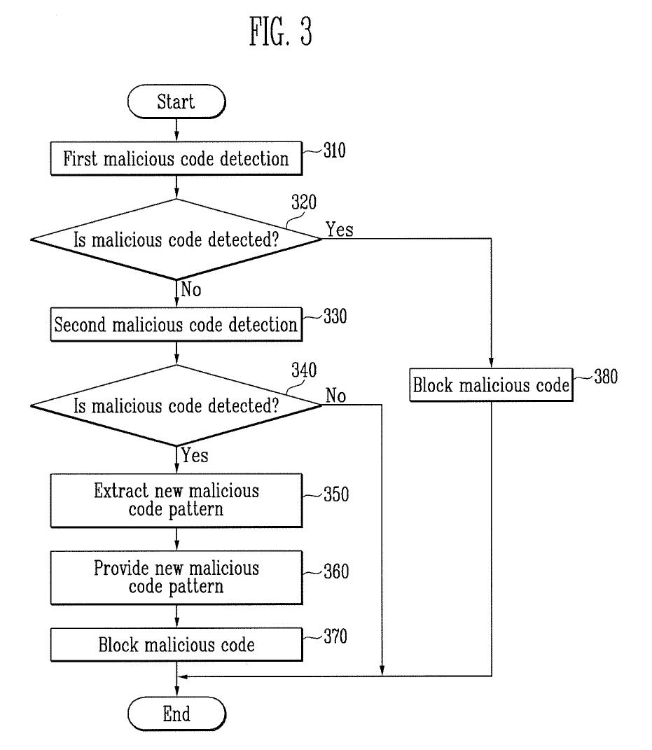

FIG. 3 is a flowchart showing a method of blocking malicious code according to an exemplary embodiment of the present invention.

Referring to FIG. 3, a first malicious code detector performs first malicious code detection for determining whether or not a received e-mail includes malicious code, on the basis of stored malicious code patterns (310). When a malicious code is detected through the first malicious code detection (320), the first malicious code detector blocks the malicious code by deleting the e-mail including the malicious code or using another method (380).

When no malicious code is detected through the first malicious code detection (320), a second malicious code detector performs second malicious code detection according to a method other than pattern-based detection using a virtual machine, etc., (330). When a malicious code is not detected through the second malicious code detection (340), the received e-mail does not include malicious code, and thus the malicious code blocking process is finished.

When a malicious code is detected through the second malicious code detection (340), a pattern extractor extracts a new malicious code pattern from the detected malicious code (350). To extract the new malicious code pattern, the pattern extractor may compare system state images before and after the malicious code is executed, or monitor the system using a debugger, etc., while the malicious code is executed.

When extraction of the new malicious code pattern is completed, the malicious code blocking agent provides the new malicious code pattern to other malicious code blocking agents through a pattern providing server (360). Here, the other malicious code blocking agents store the received new malicious code pattern and may use it to detect malicious codes afterwards. Therefore, the system for blocking malicious code according to an exemplary embodiment of the present invention can rapidly and effectively cope with the spread of a malicious code having a new pattern.

When the providing of the pattern is completed, the second malicious code detector blocks the malicious code by deleting the e-mail including the malicious code or using another method (370).

According to the present invention, when one terminal detects a new malicious code pattern, a pattern providing server rapidly provides the new malicious code pattern to other terminals, and thus it is possible to rapidly and flexibly cope with the spread of malicious codes having new patterns.

In addition, the new malicious code pattern is provided to malicious code blocking agents connected with the pattern providing server, and thus it is possible to set an unlimited protection boundary against the spread of malicious code.

Furthermore, the present invention performs pattern-based detection on all malicious codes except those that correspond to new patterns, and thus it is possible to maintain the efficiency of pattern-based detection, which requires a relatively small amount of resources.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for blocking malicious code, comprising:
a first malicious code detector for determining whether or not a received e-mail includes malicious code, on the basis of previously stored malicious code patterns;
a second malicious code detector for performing second malicious code detection on a received e-mail determined by the first malicious code detector not to include malicious code;
a pattern extractor for extracting a new malicious code pattern from malicious code detected by the second malicious code detector; and
a transceiver for transferring the extracted new malicious code pattern to a pattern providing server.

2. The apparatus of claim 1, wherein the transceiver receives the new malicious code pattern from the pattern providing server, and the first malicious code detector stores the received new malicious code pattern and uses the stored new malicious code pattern to determine whether or not a subsequently received e-mail includes malicious code.

3. The apparatus of claim 1, wherein the second malicious code detector performs the second malicious code detection using a virtual machine.

4. The apparatus of claim 1, wherein the first and second malicious code detectors delete or return an e-mail determined to include malicious code.

5. The apparatus of claim 1, further comprising:
an authenticator for performing authentication before the transceiver transfers the new malicious code pattern.

6. The apparatus of claim 1, wherein the transceiver directly transfers the new malicious code pattern to a transceiver of another apparatus for blocking malicious code.

7. A system for blocking malicious code, comprising:
a plurality of malicious code blocking agents for detecting and blocking malicious code on the basis of stored malicious code patterns, detecting malicious code having a new malicious code pattern different from the stored malicious code patterns, and extracting the new malicious code pattern from the detected malicious code; and
a pattern providing server for providing the new malicious code pattern received from one of the malicious code blocking agents to the other malicious code blocking agents in a network.

8. The system of claim 7, wherein the malicious code blocking agents each comprise:
a first malicious code detector for determining whether or not a received e-mail includes malicious code, on the basis of the previously stored malicious code patterns;
a second malicious code detector for performing second malicious code detection on a received e-mail determined by the first malicious code detector not to include malicious code;
a pattern extractor for extracting the new malicious code pattern from the malicious code detected by the second malicious code detector; and
a transceiver for exchanging the extracted new malicious code pattern with the pattern providing server.

9. The system of claim 8, wherein the second malicious code detector performs the second malicious code detection using a virtual machine.

10. The system of claim 7, wherein the pattern providing server comprises:
a transceiver for exchanging the new malicious code pattern with the malicious code blocking agent; and
a pattern verifier for verifying the new malicious code pattern.

11. The system of claim 10, wherein the pattern verifier verifies the new malicious code pattern using a virtual machine.

12. The system of claim 7, wherein one of the malicious code blocking agents directly transfers the extracted new malicious code pattern to the other malicious code blocking agents in the network.

13. The system of claim 7, wherein the malicious code blocking agents and the pattern providing server each comprise:
an authenticator for performing authentication before the new malicious code pattern is exchanged.

14. A method of blocking malicious code in a malicious code blocking system comprising a plurality of malicious code blocking agents and a pattern providing server, the method comprising:
performing, at a malicious code blocking agent, first malicious code detection for detecting malicious code in a received e-mail on the basis of stored malicious code patterns;
when no malicious code is detected through the first malicious code detection, performing, at the malicious code blocking agent, second malicious code detection using a virtual machine;
extracting, at the malicious code blocking agent, a new malicious code pattern from a malicious code detected through the second malicious code detection; and
transferring, at the malicious code blocking agent, the extracted new malicious code pattern to the pattern providing server.

15. The method of claim 14, further comprising:
deleting or returning, at the malicious code blocking agent, a received e-mail determined through the first malicious code detection to include malicious code.

16. The method of claim 14, further comprising:
deleting or returning, at the malicious code blocking agent, a received e-mail determined through the second malicious code detection to include malicious code.

17. The method of claim 14, further comprising:
providing, at the pattern providing server, the new malicious code pattern received from the malicious code blocking agent to the other malicious code blocking agents in a network.

18. The method of claim 17, further comprising:
verifying, at the pattern providing server, the new malicious code pattern received from the malicious code blocking agent.

19. The method of claim 18, wherein, in the verifying the new malicious code pattern received from the malicious code blocking agent at the pattern providing server, the new malicious code pattern is verified using a virtual machine.

20. The method of claim 14, further comprising:
performing, at the malicious code blocking agent and the pattern providing server, an authentication process.
